(19) United States
(12) Patent Application Publication
(10) Pub. No.: US 2009/0322777 A1
(43) Pub. Date: Dec. 31, 2009

(54) UNIFIED TEXTURE COMPRESSION FRAMEWORK

(75) Inventors: Yan Lu, Beijing (CN); Wen Sun, Hefei (CN); Feng Wu, Beijing (CN); Shipeng Li, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,496

(22) Filed: Jun. 26, 2008

(51) Int. Cl. G09G 5/00

(52) U.S. Cl. 345/582

(57) ABSTRACT

A method for compressing textures. A first block of texels is transformed from a red-green-blue (RGB) space to a second block of texels in a luminance-chrominance space. The first block has red values, green values and blue values. The second block has luminance values and chrominance values. The chrominance values may be based on a sum of the red values, a sum of the green values and a sum of the blue values. The chrominance values may be sampled for a first subset of texels in the second block. The luminance values and the sampled chrominance values may be converted to an 8-bit integer format. The luminance values of the first subset may be modified to restore a local linearity property to the first subset. The second block may be compressed into a third block.

### BACKGROUND

High dynamic range (HDR) imaging technologies have introduced a new era of recording and reproducing the real world with digital imaging. While traditional low dynamic range (LDR) images only contain device-referred pixels in a very limited color gamut, HDR images provide the real radiance values of natural scenes. HDR textures facilitate improvements in the lighting and post-processing of images, resulting in unprecedented reality in rendering digital images. Thus, supporting HDR textures has become the trend in designing both graphics hardware and application programming interfaces (APIs). However, LDR textures continue to be indispensable to efficiently support existing features of imaging technologies, such as decal maps, that do not typically use the expansive HDR resolution.

One of the challenges in using textures in imaging is that the size of textures is generally large. The LDR textures in typical 24 bits per pixel (bpp) raw red-green-blue (RGB) format typically consume too much storage and bandwidth. HDR textures, which are usually in half-floating or floating-point format in current rendering systems, can cost 2 to 4 times more space than the raw LDR textures. Large texture size constrains the number of HDR textures available for rendering a scene. Large texture size also limits the frame rate for a given memory bandwidth, especially when complicated filtering methods are used. These limits on the available textures and the frame rate constrain the quality of digital imaging in rendering a scene.

Texture compression (TC) techniques can effectively reduce the memory storage and memory bandwidth resources used in real-time rendering. For LDR textures, many compression schemes have been devised, including the de facto standard, DirectX® texture compression (DXTC), which may also be known as S3TC. DXTC has been widely supported by commodity graphics hardware.

### SUMMARY

In general, one or more implementations of various technologies described herein are directed towards a unified texture compression framework. In one implementation, the unified texture compression framework may compress both low dynamic range (LDR) and high dynamic range (HDR) textures. The LDR/HDR textures may be compressed at compression ratios of 8 bits per pixel (bpp), or 4 bpp. The LDR textures may be converted to an HDR format before being compressed.

In one implementation, the textures may first be compressed to 8 bpp. The 8 bpp-compressed textures may then be compressed to 4 bpp. In another implementation, the original LDR/HDR textures may be compressed directly to 4 bpp.

The LDR/HDR textures may be transformed from a red, green, and blue (RGB) space to a luminance-chrominance space. A DirectX® texture-like linear fitting algorithm may be used to perform joint channel compression on the textures in the luminance-chrominance space. In 4 bpp compression, the chrominance representation of the textures may be based on a sampling of texels within each texture. The sampled texels may also be used in the luminance representation of the texels.

In another implementation, the compressed textures may be rendered from either 8 bpp or 4 bpp compressed textures. The textures compressed at 4 bpp may be first decoded to 8 bpp compression before a texel shader renders the images represented by the textures.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system, in accordance with implementations described herein.

FIG. 2 illustrates a data flow diagram of a method for compressing original textures, in accordance with implementations described herein.

FIG. 3 illustrates a data flow diagram of a method for compressing original textures to 8 bpp textures, in accordance with implementations described herein.

FIGS. 4A-4D illustrate 3-dimensional graphs of texels in color spaces, according to implementations described herein.

FIG. 5 illustrates a modifier table according to implementations of various technologies described herein.

FIG. 6 illustrates a data structure that contains 8 bpp textures, in accordance with implementations of various technologies described herein.

FIG. 7 illustrates a decoding logic for recovering RGB channels from 8 bpp textures, according to implementations of various technologies described herein.

FIG. 8 illustrates a data structure that contains 4 bpp textures, in accordance with implementations of various technologies described herein.

FIG. 9A illustrates a data flow diagram of a method for compressing 8 bpp textures to 4 bpp textures, in accordance with implementations described herein.

FIG. 9B illustrates an example color index block, in accordance with implementations described herein.

FIG. 10 illustrates a decoding logic for recovering RGB channels from the 4 bpp textures, according to implementations of various technologies described herein.

FIG. 10A illustrates a flow chart of a method for decoding 4 bpp textures to 8 bpp textures.

FIG. 10B illustrates a block diagram indicating data copied from the 4 bpp textures to the 8 bpp textures, in accordance with implementations described herein.

FIG. 11 illustrates a block diagram of a processing environment in accordance with implementations described herein.

### DETAILED DESCRIPTION

As to terminology, any of the functions described with reference to the figures can be implemented using software, firmware, hardware (e.g., fixed logic circuitry), manual processing, or a combination of these implementations. The term “logic, “module,” “component,” or “functionality” as used herein generally represents software, firmware hardware, or a combination of these implementations. For instance, in the case of a software implementation, the term “logic,” “module,” “component,” or “functionality” represents program code (or declarative content) that is configured to perform specified tasks when executed on a processing device or devices (e.g., CPU or CPUs). The program code can be stored in one or more computer readable media.

More generally, the illustrated separation of logic, modules, components and functionality into distinct units may reflect an actual physical grouping and allocation of such software, firmware, and/or hardware, or may correspond to a conceptual allocation of different tasks performed by a single software program, firmware program, and/or hardware unit. The illustrated logic, modules, components, and functionality can be located at a single site (e.g., as implemented by a processing device), or can be distributed over plural locations.

The terms “machine-readable media” or the like refers to any kind of medium for retaining information in any form, including various kinds of storage devices (magnetic, optical, solid state, etc.). The term machine-readable media also encompasses transitory forms of representing information, including various hardwired and/or wireless links for transmitting the information from one point to another.

The techniques described herein are also described in various flowcharts. To facilitate discussion, certain operations are described in these flowcharts as constituting distinct steps performed in a certain order. Such implementations are exemplary and non-limiting. Certain operations can be grouped together and performed in a single operation, and certain operations can be performed in an order that differs from the order employed in the examples set forth in this disclosure.

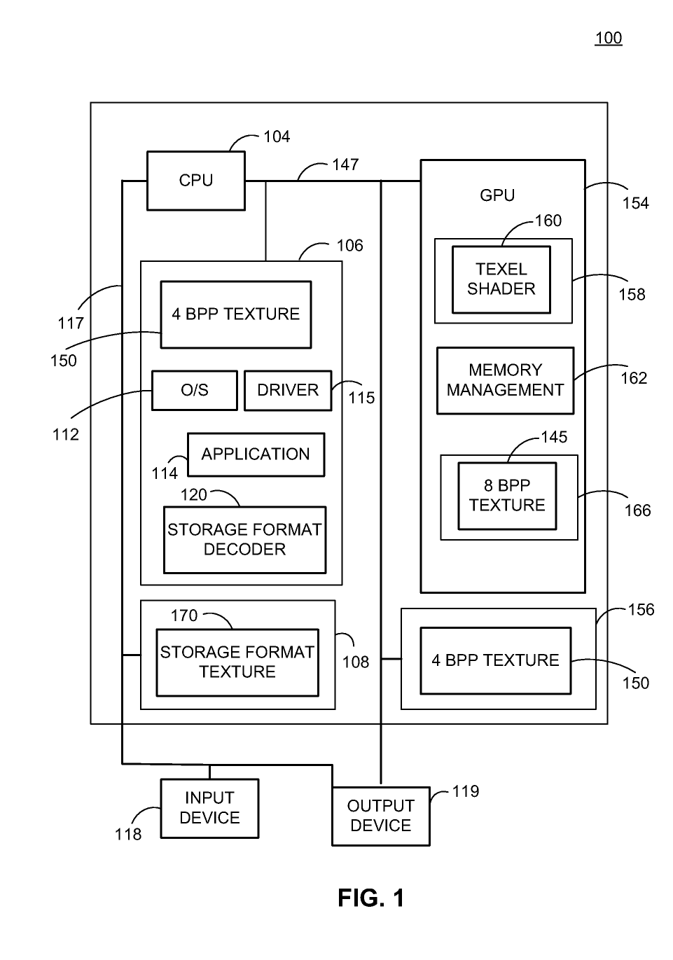

FIG. 1 illustrates a schematic diagram of a computing system 100 in accordance with implementations described herein. The computer system 100 includes a central processing unit (CPU) 104, a system (main) memory 106, and a storage 108, communicating via a system bus 117. User input is received from one or more user input devices 118 (e.g., keyboard, mouse) coupled to the system bus 117.

The computing system 100 may be configured to facilitate high performance processing of texel data, i.e., graphics data. For example, in addition to the system bus 117, the computing system 100 may include a separate graphics bus 147. The graphics bus 147 may be configured to facilitate communications regarding the processing of texel data. More specifically, the graphics bus 147 may handle communications between the CPU 104, graphics processing unit (GPU) 154, the system memory 106, a texture memory 156, and an output device 119.

The system bus 117 and the graphics bus 147 may be any of several types of bus structures, including a memory bus or memory controller, a peripheral bus, and a local bus using any of a variety of bus architectures. By way of example, and not limitation, such architectures may include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, PCI Express (PCIE), integrated device electronics (IDE), serial advantage technology attachment (SATA), and accelerated graphics port (AGP).

The system memory 106 may store various programs or applications, such as an operating system 112. The operating system 112 may be any suitable operating system that may control the operation of a stand-alone or networked computer, such as Windows® Vista, Mac OS® X, Unix-variants (e.g., Linux® and BSD®), and the like.

The system memory 106 may also store an application 114 that generates images, such as 3-D images, for display on the output device 119. The application 114 may be any software that generates texel data, such as a game, or other multi-media application.

The system memory 106 may further store a driver 115 for enabling communication with the GPU 154. The driver 115 may implement one or more standard application program interfaces (APIs), such as Open Graphics Library (OpenGL) and Microsoft DirectX®. By invoking appropriate API function calls, the operating system 112 may be able to instruct the driver 115 to transfer 4 bit per pixel (bpp) textures 150 to the GPU 154 via the graphics bus 147 and invoke various rendering functions of the GPU 154. Data transfer operations may be performed using conventional DMA (direct memory access) or other operations.

The system memory 106 may also store a storage format decoder 120. In response to requests from the GPU 154, the storage format decoder 120 may retrieve storage format textures 170 from a storage 108, decode the storage format textures 170 into 4 bpp textures 150, and load the 4 bpp textures 150 into the system memory 106.

The computing system 100 may further include the storage 108, which may be connected to the bus 117. The storage 108 may contain storage format textures 170. The storage format textures 170 may be texel data that is compressed on top of the 4 bpp textures 150. As the storage 108 may not use random addressing to access data, the storage 108 may store texel data with higher rates of compression than 4 bpp.

Advantageously, because the storage format textures 170 occupy less storage then the 4 bpp textures 150, transferring the storage format textures 170 to the system memory uses less bandwidth on the system bus 117 than the 4 bpp textures 150 would if the 4 bpp textures 150 were stored in the storage 108 instead of the storage format textures 170. Reducing the amount of bandwidth used improves the efficiency of processing texel data.

Examples of storage 108 include a hard disk drive for reading from and writing to a hard disk, a magnetic disk drive for reading from and writing to a removable magnetic disk, and an optical disk drive for reading from and writing to a removable optical disk, such as a CD ROM or other optical media. The storage 108 and associated computer-readable media may provide nonvolatile storage of computer-readable instructions, data structures, program modules and other data for the computing system 100.

It should be appreciated by those skilled in the art that the computing system 100 may also include other types of storage 108 and associated computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

Visual output may be provided on an output device 119 (e.g., a conventional CRT, TV or LCD based monitor, projector, etc.) operating under control of the GPU 154. The GPU 154 may include various components for receiving and processing graphics system commands received via the graphics bus 147. The GPU 154 may include a display pipeline 158, a memory management unit 162, and a texture cache 166.

The display pipeline 158 may generally be used for image processing. The display pipeline 158 may contain various processing modules configured to convert 8 bpp textures 145 into texel data suitable for displaying on the output device 119. In one implementation, the display pipeline 158 may include a texel shader 160.

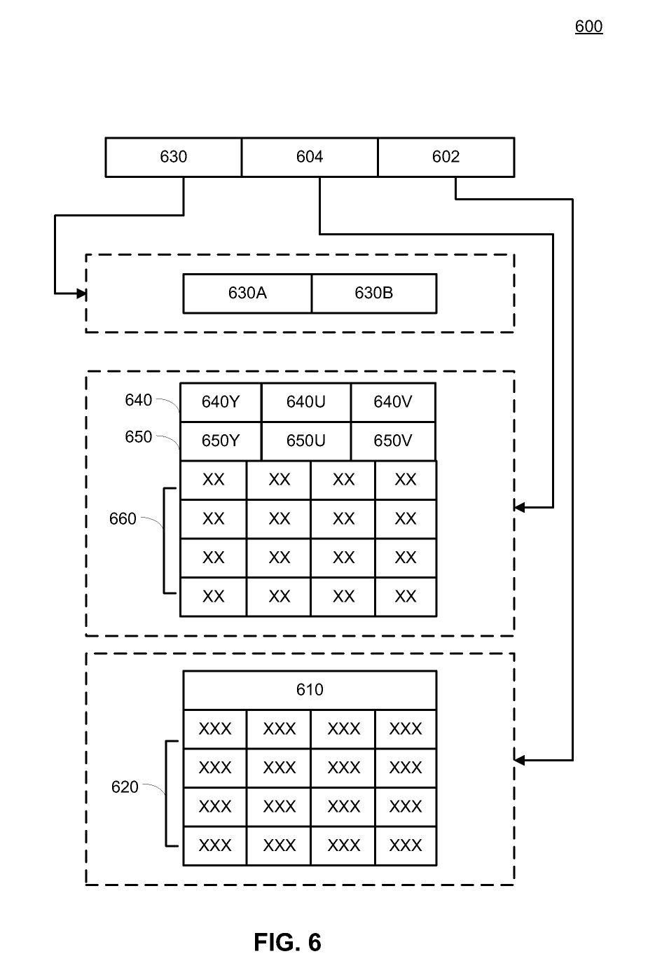

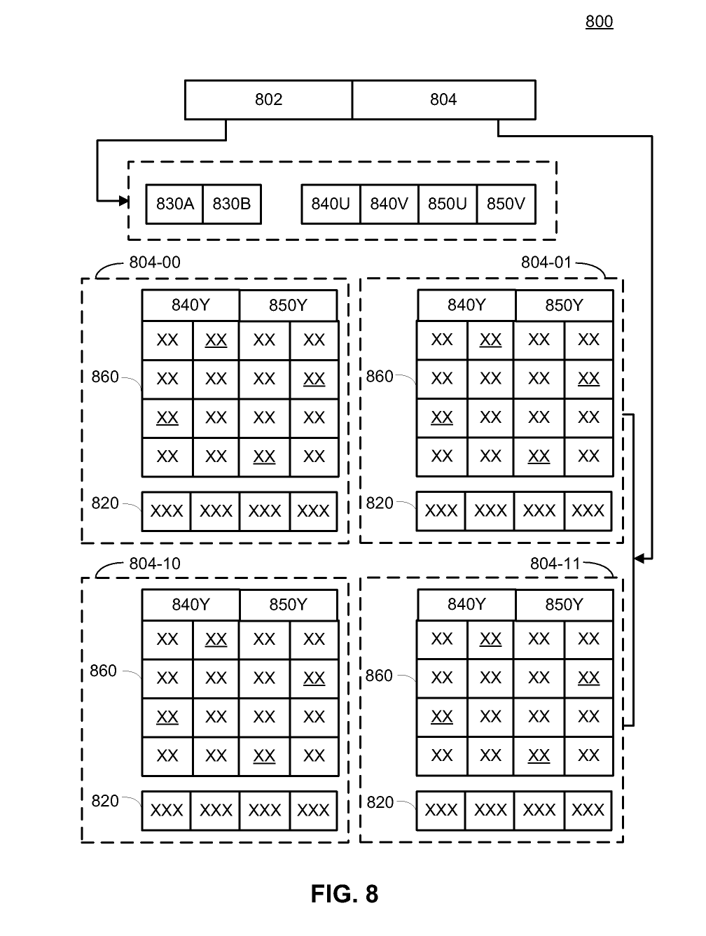

The texel shader 160 may decompress the 4 bpp textures 150 into 8 bpp textures 145. Additionally, the texel shader 160 may load the 8 bpp textures 145 into a texture cache 166. The texture cache 166 may be a cache memory that is configured for rapid I/O, facilitating high performance processing for the GPU 154 in rendering images, including 3-D images. The 8 bpp textures 145, and 4 bpp textures 150 are described in greater detail with reference to FIGS. 6 and 8, respectively.

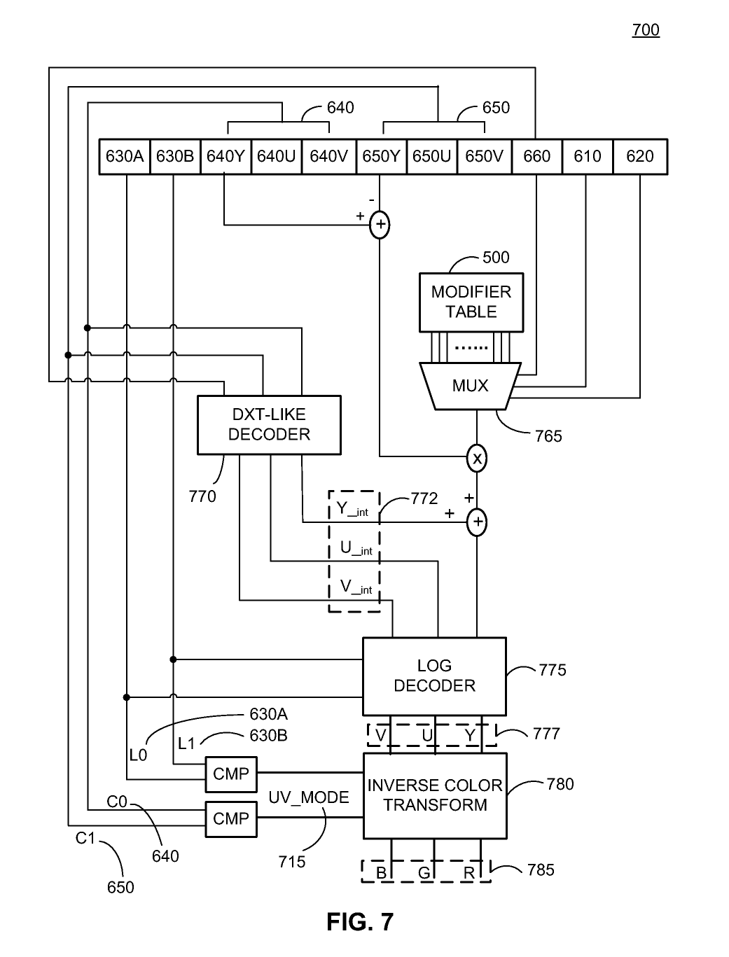

Additionally, the texel shader 160 may perform real-time image rendering, whereby the 8 bpp textures 145 and/or the 4 bpp textures 150 may be configured for processing by the GPU 154. The texel shader 160 is described in greater detail with reference to the description of FIGS. 7, 10, 11A, and 11B.

The memory management unit 162 may read the 4 bpp textures 150 from the system memory 106, and load the 4 bpp textures 150 into a texture memory 156. The texture memory 156 may be specialized RAM (TRAM) that is designed for rapid I/O, facilitating high performance processing for the GPU 154 in rendering images, including 3-D images. Alternately, if the 4 bpp textures 150 are loaded into the texture memory 156, the memory management unit 162 may read the 4 bpp textures 150 from the texture memory 156 to facilitate decompression or image rendering by the texel shader 160.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

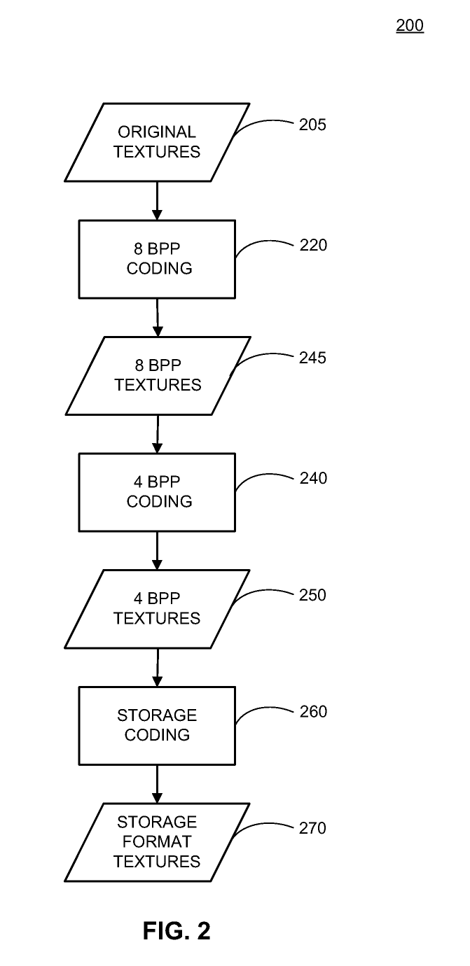

FIG. 2 illustrates a data flow diagram of a method 200 for compressing original textures 205 in accordance with implementations described herein. The original textures 205 may be raw texel data, in the form of high or low dynamic range (HDR or LDR) textures. In the scenario where the original textures 205 include LDR textures, the LDR texture data may be converted to an HDR texture format. More specifically, HDR textures typically describe images as 16-bit floating- or half-point values in red, green, and blue (RGB) channels, whereas LDR textures typically describe images as 8-bit integer values in RGB channels. Converting LDR texture data to the HDR format may include a simple conversion of the 8-bit LDR integer values to 16-bit half- or floating-point values.

Advantageously, by converting the LDR textures to the HDR format, a unified compression framework may be provided for rendering images from both LDR and HDR textures.

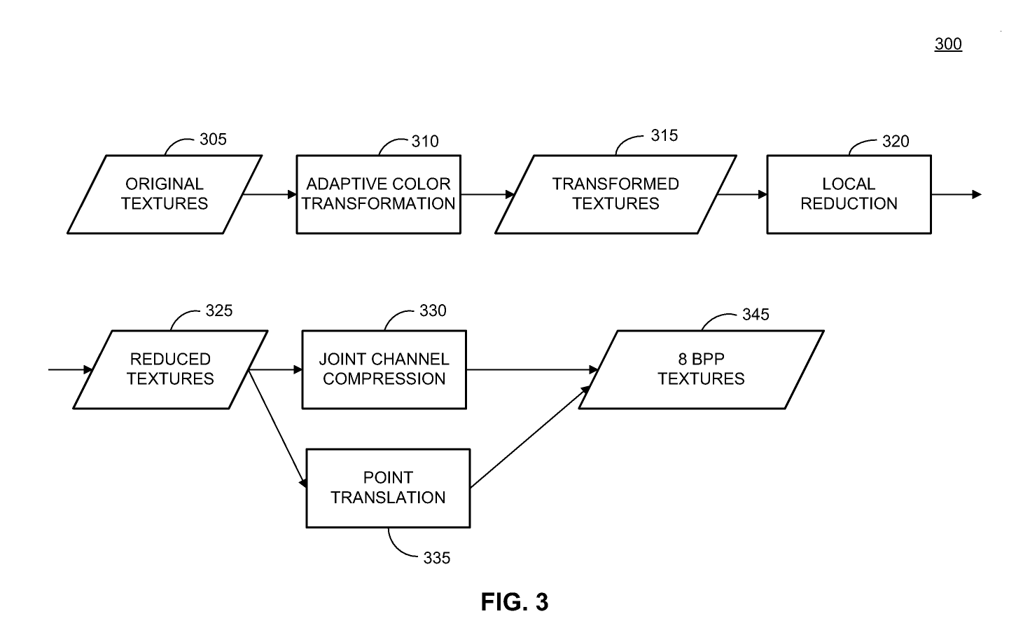

The original textures 205 may be input to an 8 bpp coding process 220. The 8 bpp coding process 220 may compress the original textures 205 at a compression ratio of 8 bpp to produce 8 bpp textures 245. The 8 bpp coding process 220 is described in greater detail with reference to FIGS. 3-5.

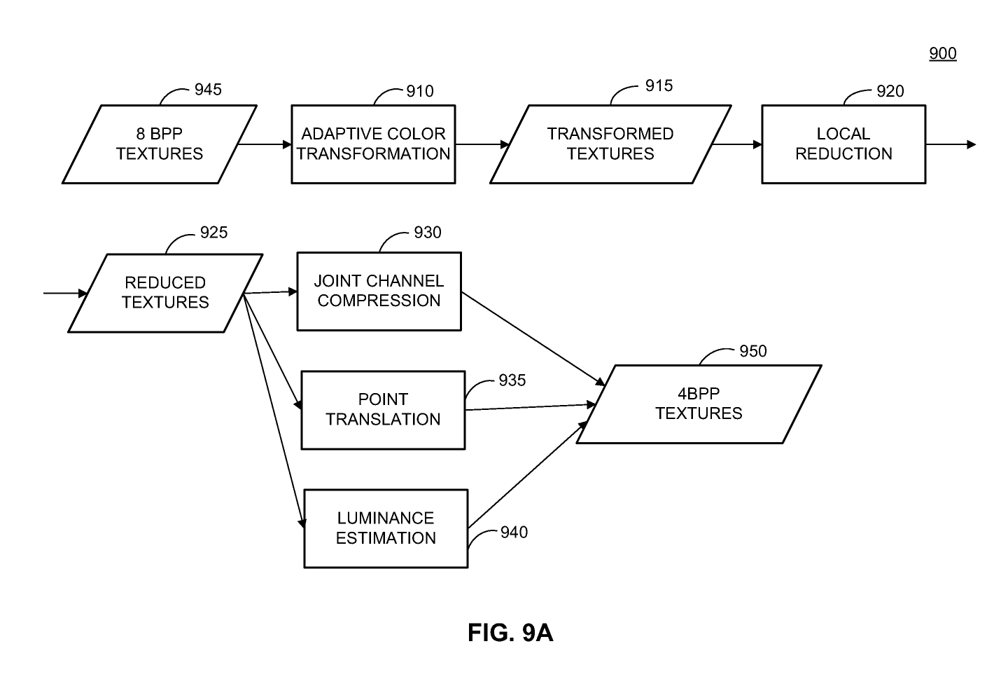

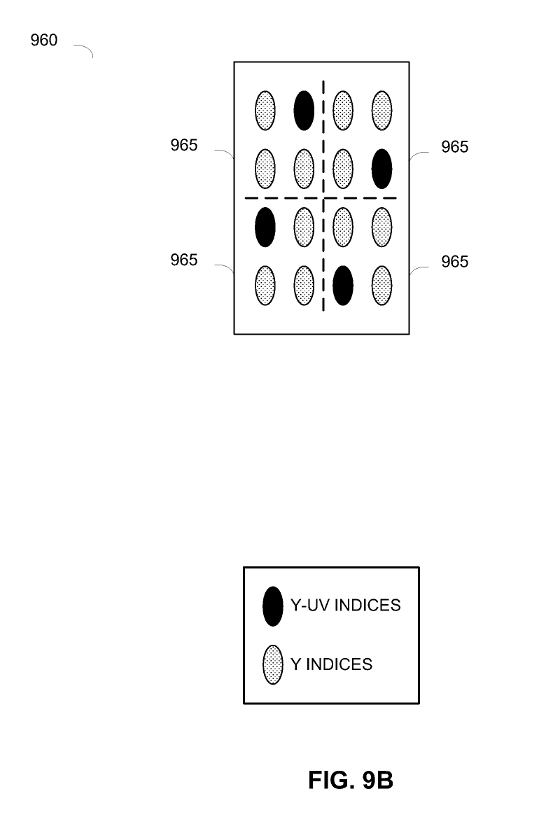

The 8 bpp textures 245 may be input to a 4 bpp coding process 240. The 4 bpp coding process 240 may compress the 8 bpp textures at a compression ratio of 4 bpp to produce 4 bpp textures 250. The 4 bpp coding process 240 is described in greater detail with reference to FIGS. 9A-9B.

The 4 bpp textures 250 may be input to a storage coding process 260 that produces storage format textures 270. The storage coding process 260 may employ compression techniques, such as ZIP or Huffman coding, to further compress the 4 bpp textures 250.

FIG. 3 illustrates a data flow diagram of a method 300 for compressing original textures 305 to 8 bpp textures 345 in accordance with implementations described herein. The method 300 may perform the 8 bpp coding process 220 described with reference to FIG. 2.

In operation, original textures 305 may be input to an adaptive color transformation process 310. The original textures 305 may be partitioned into 4×4 blocks of 16 texels. The adaptive color transformation process 310 may produce the transformed textures 315 by transforming the original textures 305 from an RGB space to a luminance-chrominance space. Herein, the luminance-chrominance space may also be referred to as a Y-UV space. In one implementation, the adaptive color transformation process 310 is based on HDR color transformation, which may include converting RGB values to Y-UV values.

Typically, HDR color transformation is determined as follows:

$$Y = {\sum }_{t ∈ \{ r , g , b \}} {w}_{t} {C}_{t}$$

$${S}_{t} = \frac{{w}_{t} {C}_{t}}{Y} , for t ∈ \{ r , g , b \}$$

where Y is the luminance channel, and Sₜ are chrominance channels corresponding to R, G, and B. wₜ is a constant weight. It should be noted that only two of the chrominance channels need to be determined for color transformation because the third channel may be derived based on the values of the other two chrominance channels. For example, each of the R, G, and B values may derived as follows:

R=Sᵣ×Y/wᵣ

G=S_{g}×Y/w_{g}

B=(Y−wᵣR−w_{g}G)/w_{b}

However, if the third channel is not encoded during compression, in this case, the blue channel may accumulate errors, which can be relatively large. The amount of accumulated error can be controlled, however, by adaptively selecting which channel to leave out of the color transformation. As such, an error accumulative channel may be determined from one of the R, G, and B channels. In one implementation, the error accumulation channel, also referred to herein as uv_mode, may be derived for each texel, calculated as:

$$uv\_mode ≡ m = {arg max}_{t ∈ \{ r , g , b \}} \{ {S}_{t} \}$$

Accordingly, in the adaptive color transformation process 310, the Y-UV values may be calculated as follows:

$$Y = {w}_{r} R + {w}_{g} G + {w}_{b} B$$

$$U = \frac{min \{ {w}_{r} R , {w}_{g} G \}}{Y}$$

$$V = \frac{min \{ max \{ {w}_{r} R , {w}_{g} G \} , {w}_{b} B \}}{Y}$$

where w_{r/g/b} are weights that balance the importance of RGB values in a transformation to Y-UV space. In one implementation, wᵣ=0.299, w_{g}=0.587, and w_{b}=0.114.

Here, the dominant chrominance channel may not be included in the color adaptive color transformation, and accordingly not included in the 8 bpp texture 345. By leaving the highest, or dominant, chrominance value out of the transformation, the relative error may be controlled because the values of the two encoded chrominance channels may fall in the range of [0, 0.5]. In one implementation, the error accumulation channel may be determined per-block instead of per-texel. In such an implementation, the color values for each texel may be summed by channel, providing a total sum for the block for each of the three channels: R, G, and B. In other words, the two channels with the lowest total sums for the block may be selected for color transformation.

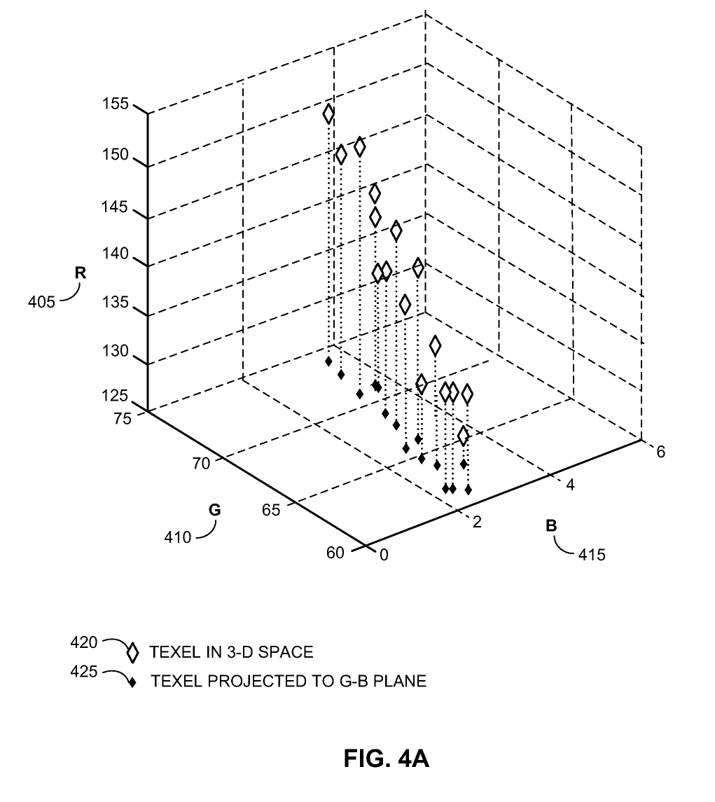

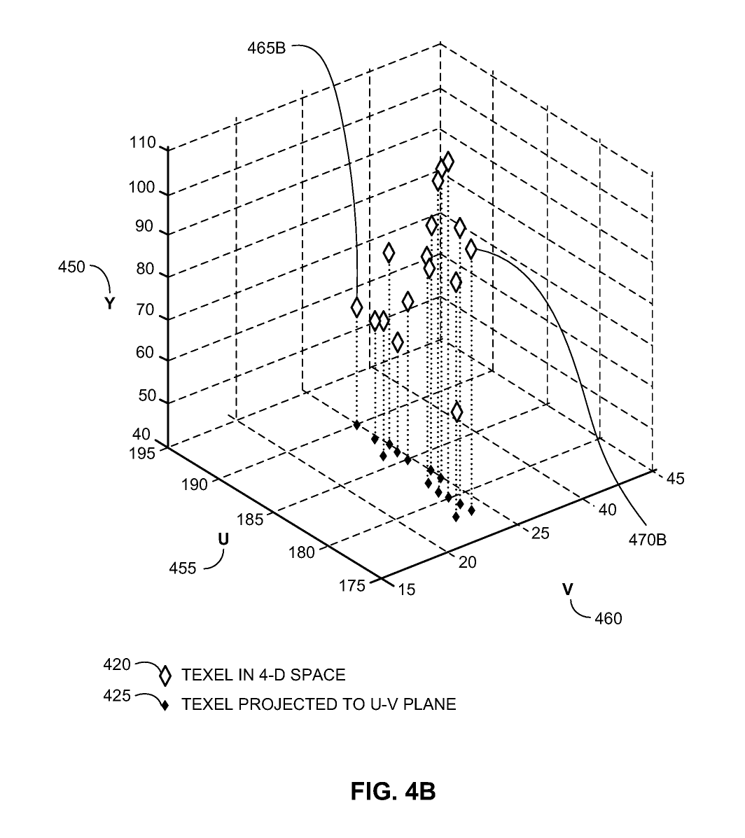

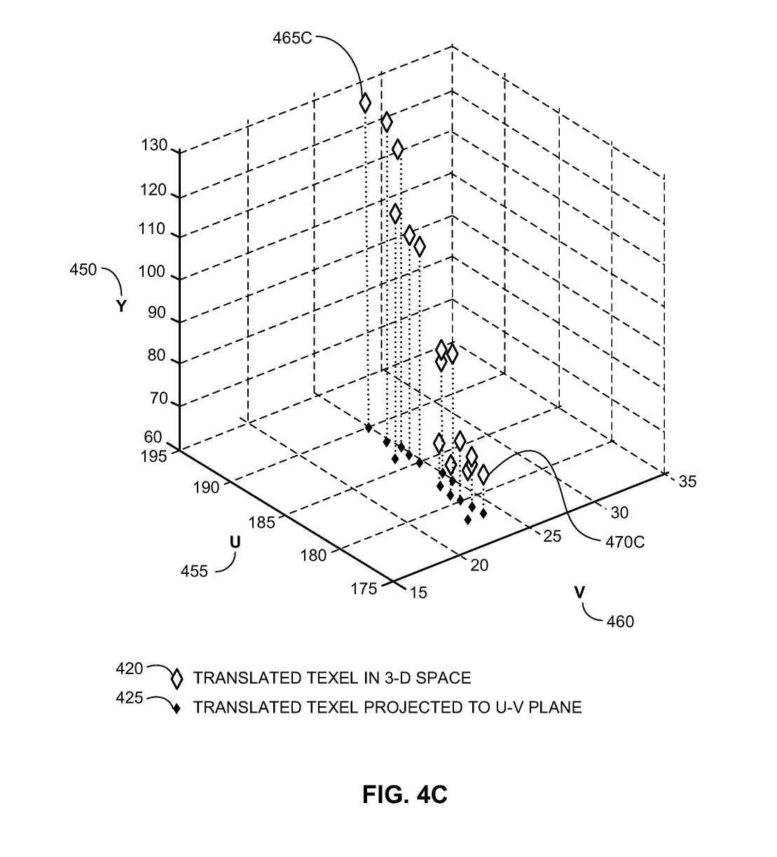

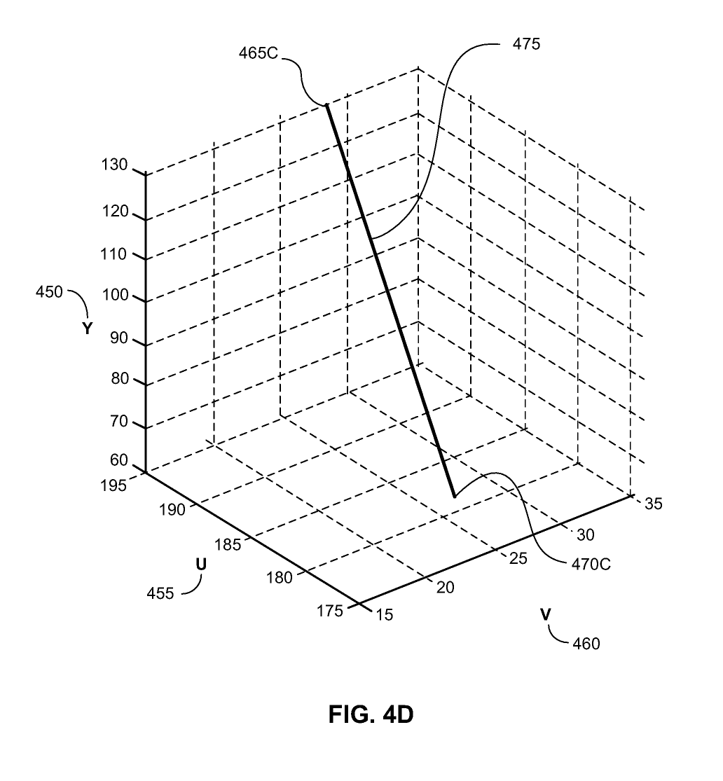

FIGS. 4A and 4B illustrate graphs of texels according to implementations of various technologies described herein. More specifically, FIGS. 4A and 4B graphically illustrate the adaptive color transformation process 310. FIG. 4A illustrates a 3-dimension Cartesian coordinate system with an R-axis 405, a G-axis 410, and a B-axis 415. Each texel in one 4×4 block of the original textures 305 is represented as a diamond 420. The position in the RGB space is determined by the values of each of the R, G, and B components of the texels. The projection to the UV-plane 425 is provided to illustrate the R-positioning of each diamond 420.

FIG. 4B illustrates a 3-dimension Cartesian coordinate system with a Y-axis 450, a U-axis 455, and a V-axis 460. Each texel in one 4×4 block of the original textures 305 may be transformed in the Y-UV space. The position of each texel in the Y-UV space is determined by the values of each of the Y, U, and V components of the texels as determined by the formulas described above. Because the transformation is adaptive, the U and V values may represent any two of the original R, G, and B values depending on the uv_mode determined as described above.

Returning to FIG. 3, the transformed textures 315 may be input to a local reduction process 320. The transformed textures 315 may represent the luminance and chrominance values (the Y-UV values) in 16-bit floating-point format, which typically is more difficult to compress than integer values. Accordingly, the local reduction process 320 may convert the 16-bit floating point Y-UV values to an 8-bit integer format. The values in 8-bit integer format may be included in reduced textures 325.

To convert the 16-bit floating- or half-point Y values to 8-bit integers, a global luminance range may be determined. The global luminance range may be the upper and lower bound of values in the Y channel for all the texels in the 4×4 block. The upper bound may be derived from 4-bit quantizing and rounding up the maximal luminance value to the nearest integer. The lower bound may be derived from 4-bit quantizing and rounding down to the nearest integer. Each of the 16-bit floating point Y values may then be mapped into relative values within the global luminance range. The relative Y-values may then be quantized using linear quantization in log 2 space.

To convert the 16-bit floating- or half-point UV values to 8-bit integers, linear encoding and log encoding may be alternatively employed for each 4×4 block of texels. The values of chrominance channels UV generally fall into [0, 1], and thus may be directly quantized into 256 levels in [0,1], i.e. 8-bit integer values.

The reduced textures 325 may represent each of the Y-UV values as 8-bit integers for each texel in a 4×4 block. Additionally, the reduced textures 325 may include the global luminance range values (upper and lower bound luminance values in 4-bit integer format). The reduced textures 325 may be input to a joint channel compression process 330 and a point translation process 335, which collectively produce the 8 bpp textures 345.

DirectX Texture Compression (DXTC) is typically applied to raw LDR textures that are represented as Y-UV channel values in 8-bit integer format. As such, the joint channel compression process 330 may apply a DXT-like linear fitting algorithm to the reduced textures 325. However, applying the DXT-like linear fitting algorithm directly to the reduced textures 325 may produce large distortions because the adaptive color transformation process 310 and the local HDR reduction process 320 may remove a local linearity property in the Y-UV color spaces that is relied upon by the DXT-like linear fitting algorithm. As such, the local linearity property may be restored by the point translation process 335 before employing the DXT-like linear fitting algorithm in the joint channel compression process 330. The DXT-like linear fitting algorithm may further compress the 8-bit Y-UV values to produce the 8 bpp textures 345.

The point translation process 335 may reshape distribution of each 4×4 block in the reduced textures 325 within the Y-UV space such that the local linearity property may be restored. In doing so, the point translation process 335 may shift the texels in the Y-UV space such that each point is positioned close to a single line segment in the Y-UV space. In one implementation, each texel may be shifted solely along the Y-axis. In another implementation, a modifier table may be used to determine a re-distribution of each 4×4 block of the reduced textures 325.

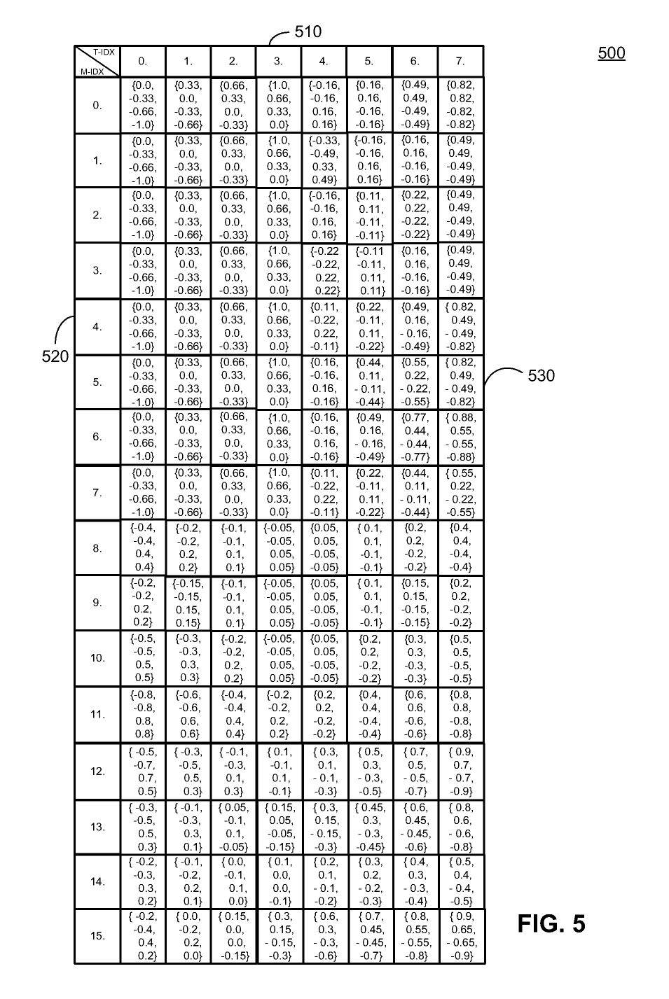

FIG. 5 illustrates a modifier table 500 according to implementations of various technologies described herein. The modifier table 500 may include a list of modifier values 530 along T_idx 510 columns and M_idx 520 rows. The modifier values 530 may be used to shift the Y-value of each texel in the block for the point translation process 335.

The modifier values 530 may be selected from the modifier table 500 according to which values attenuate the reconstruction error. The DXT-like linear-fitting algorithm may determine base chrominance colors and color indices for each 4×4 block. The base chrominance colors, and color indices may represent chrominance values of each texel in the 4×4 block. In one implementation, the color-indices may be 2-bit values.

All possible T_idx 510 values [0,1 . . . 15] and M_idx 520 values [0,1 . . . 7] may be enumerated. Each combination of T_idx 510 and M_idx 520 values may identify an entry in the modifier table 500. The modifier value 530 for a texel may be selected from the 4 values in the identified entry based on the 2-bit color index for the texel.

The T_idx 510 and M_idx 520 values that provide the minimal reconstruction error for each texel may then be determined. Finally, the per-block T idx 510 and per-texel M_idx 520 may be selected to minimize the overall block reconstruction error.

FIGS. 4B and 4C illustrate graphically the point translation process 335. In FIG. 4B, two texel points, 465B and 470B, are noted. FIG. 4C illustrates the same texels after point translation. More specifically, the texel points 465C and 470C illustrate a translation along the Y-axis, whereby point 465C has a greater Y-value than 465B, and point 470C has a lower Y-value than point 470B.

FIG. 4D illustrates a line segment 475 that is approximated by the point-translated texels in FIG. 4C, where points 465C and 470C represent endpoints of the line segment 475. It should be noted however, in implementations described herein, the translated texel points may only approximate endpoints of the line segment 475, and not represent actual endpoints.

FIG. 6 illustrates a data structure 600 that contains the 8 bpp textures 345, in accordance with implementations of various technologies described herein. The data structure 600 may represent a format of color data for each 4×4 block of texels in the 8 bpp textures 345. The data structure 600 may include a global base luminance block 630, a DXT-like block 604, and a modifier block 602.

The global base luminance block 630 may contain two values that represent a range of luminance values (Y-values) for all the texels in the 4×4 block. The range of Y-values may be defined by a global luminance bound 630A and a global luminance bound 630B. Either of the global luminance bound 630A and the global luminance bound 630B, may contain the upper bound, while the other may contain the lower bound.

The DXT-like block 604 may include a base color 640, a base color 650, and color indices 660. Each base color may be represented in 18 bits with Y, U, and V values. Accordingly, the base color 640 may include 6-bit values for each of 640Y, 640U, and 640V. Similarly, the base color 650 may include 6-bit values for each of 650Y, 650U, and 650V. Base color 640 and base color 650 may represent the values of endpoints of the line segment 475 approximated by the point-translated texels in one 4×4 block.

Color indices 660 may include a 2-bit value for each texel in the block. Each color index in the color indices 660 may represent (in-combination with the base color values) a value in the Y-UV space for each texel.

The modifier block 602 may include data that facilitates decompression by the texel shader 160. The modifier block 602 may include data values that represent changes to the original textures 305 introduced by the point translation process 335.

Four modifier values may be included in each entry in the modifier table 500. Each entry in the modifier table 500 may be identified by T_idx 610, and M_idx 620. The color indices 660 may identify the actual value in the entry of the modifier table 500 used for the point translation process 340. One 4-bit T_idx 610 may be recorded for each block, and one 3-bit M_idx 620 value may be recorded for each texel.

In one implementation, the uv_mode may be represented implicitly in the data structure 600 by the allocation of stored values. Because the uv_mode may indicate one of 3 possible values, a 2-bit representation may be needed to represent the uv_mode. In one implementation, the 2-bit representation may be indicated by the allocation of stored values in the base color 640, the base color 650, the global luminance bound 630A, and the global luminance bound 630B.

Since the upper luminance bound may be stored in either of the global luminance bound 630A or global luminance bound 630B, the placement of the upper and lower bounds may be used to represent the value of first bit of the uv_mode. For example, if the global luminance bound 630B contains the upper bound, i.e., the global luminance bound 630B≧global luminance bound 630A, then the first bit of uv_mode may be 1, otherwise the first bit of uv_mode may be 0.

Similarly, the values in the base color 640 and the base color 650 may be used to define the value of the second bit of the uv_mode. For example, if the value of the base color 640≧base color 650, then the second bit of uv_mode may be 1, otherwise the first bit of uv_mode may be 0.

FIG. 7 illustrates a decoding logic 700 for recovering RGB channels from the 8 bpp textures 345, according to implementations of various technologies described herein. The decoding logic 700 illustrated in FIG. 7 may be executed for each texel represented in the data structure 600. In one implementation, the decoding logic 700 may be part of a hardware implementation of the texel shader 160.

The components of the DXT-like block 604 may be input to a DXT-like decoder 770, and the 8-bit integer values of the three Y-UV channels may be recovered by decoding the color index from the color indices 660, base color value 640 and base color value 650.

The luminance range of the 4×4 block may be determined by calculating the difference between the Y components of base color 640 and base color 650. The amount of translation effected in the point translation process 335 may be recovered by multiplying the difference of the Y components by the modifier value recovered by the MUX 765.

The multiplexer (MUX) 765 may use T_idx 610, M_idx 620, and the color index from the color indices 660 to look up the modifier value in the modifier table 500. The translation amount may then be added to the Y-value determined by the DXT-like decoder 770. Modifying the Y-value may compensate for the modification to the Y-values of the texels in the point translation process 335.

The log decoder 775 may perform luminance log decoding and chrominance log or linear decoding. It should be noted that log decoding may be a combination of linear decoding and exp 2 operation. The log decoder 775 may use the global luminance range (global luminance bound 630A and global luminance bound 630B) to determine absolute floating-point Y, U, and, V values 777 based on the relative integer Y, U, and V values 772 input to the log decoder 775. As such, the log decoder 775 may perform the inverse operation of the local reduction process 320.

The inverse color transform module 780 may perform the inverse process of the adaptive color transformation process 310. The uv_mode 715 may identify the R, G, or B value left out of the adaptive color transformation process 210. By identifying the uv_mode 715, the inverse color transform module 780 may determine R, G, and B values 785 based on the Y, U, and, V values 777 output by the log decoder 775. The texel shader 160 may then render images based on the R, G, and B values 785.

As stated previously, the uv_mode 715 may be determined by comparing the global luminance bound 630A to the global luminance bound 630B, and the base color 640 to the base color 650. If the global luminance bound 630B≧global luminance value 630A, then the first bit of uv_mode 715 may be 1, otherwise the first bit of uv_mode 715 may be 0. Similarly, if the value of the base color 640≧base color 650, then the second bit of uv_mode 715 may be 1, otherwise the first bit of uv_mode 715 may be 0.

FIG. 8 illustrates a data structure 800 that contains 4 bpp textures 250, in accordance with implementations of various technologies described herein. The data structure 800 may contain shared information 802, and a block array 804. The data structure 800 may be similar to the data structure 600. However, instead of organizing the texel data in 4×4 blocks of texels, the data structure 800 may organize the texel data in 8×8 blocks of texels. As shown, the block array 804 may contain block 804-00, block 804-01, block 804-10, and block 804-11. Each block in the block array 804 may describe a 4×4 block of texels. As such, the 8×8 block of texels described by the data structure 800 is also referred to herein as a macro-block.

The shared information 802 may describe shared information about the macro-block. The shared information 802 may include global luminance bound 830A, global luminance bound 830B, base-chrominance values 840U and 840V, and base-chrominance values 850U and 850V.

The global luminance bound 830A and global luminance bound 830B may be a range of luminance values for the entire macro-block. Similar to the global luminance bounds of the data structure 600, the ordering of values within the global luminance bound 830A and global luminance bound 830B may define the first bit of the uv_mode of the macro-block.

The base-chrominance values 840U and 840V, and base-chrominance values 850U and 850V may describe a range of chrominance values that includes the chrominance values of all the texels within the macro-block. Similar to the base colors of data structure 600, the ordering of values within the base-chrominance values 840U and 840V, and base-chrominance values 850U and 850V may define the second bit of the uv_mode of the macro-block.

Each block within the block array 804 may contain a base luminance value 840Y, a base luminance value 850Y, an index block 860, and a modifier block 820. The base luminance value 840Y and base luminance value 850Y may describe a range of relative luminance values that includes relative luminance values of all the texels within one block of the macro-block.

It should be noted that the base luminance value 840Y, in combination with the chrominance values 840U and 840V may be similarly defined as the base color 640 of the data structure 600. Similarly, the base luminance value 850Y, in combination with the chrominance values 850U and 850V may be similarly defined as the base color 650 of the data structure 600.

To facilitate compression to 4 bpp, only a sampling of chrominance information may be included in the data structure 800. As such, the index block 860 may be divided into Y indices and Y-UV indices. The Y indices and the Y-UV indices may represent color values in distinct groups of texels. The Y indices may represent color values in a subset of texels within the index block 860, while the Y-UV indices may represent the color values in the remainder of the texels within the index block 860.

The Y indices may only define luminance information for their representative texels, while the Y-UV indices may define both luminance and chrominance information. Upon reconstruction, the chrominance information stored in the Y-UV indices may be shared with neighboring texels. In FIG. 8, the Y-UV indices are underlined, while the Y indices are not. The Y indices are described further with reference to FIG. 9A.

Because only a sampling of chrominance information may be stored in the color-indices, point translation may only be employed for the texels represented by the Y-UV indices. As such, the modifier block 820 may only represent modifier values for the Y-UV indices.

In the 4 bpp compression, only the first half of the modifier table 500 may be used for point translation. As such, only 3 bits may be used to represent the T_idx 510 in the macro-block.

Similar to the M_idx 620 in the data structure 600, the values in the modifier block 820 may represent the M_idx 520 in the modifier table 500. However, rather than an explicit representation, in one implementation, the T_idx 510 may be represented implicitly in the data structure 800. The implicit representation may be similar to the uv_mode representations in the data structure 600 and the data structure 800. For example, the T_idx 510 in the modifier table 500 may be indicated by the arrangement of the base luminance value 840Y and base luminance value 850Y in block 804-00, block 804-01, and block 804-10. In other words, the first bit of the T_idx 510 may be indicated by the arrangement of the base luminance value 840Y and base luminance value 850Y in block 804-00. Similarly, the second and third bits of the T_idx 510 may be represented in block 804-01 and block 804-10, respectively.

FIG. 9A illustrates a data flow diagram of a method 900 for compressing 8 bpp textures 945 to 4 bpp textures 950, in accordance with implementations described herein. The method 900 may perform the 4 bpp coding process 240 described with reference to FIG. 2. The method 900 may include an adaptive color transformation process 910, a local reduction process 920, a joint channel compression process 930, and a point translation process 935, similar to the method 300 for 8 bpp compression.

The 8 bpp textures 945 may be input to the adaptive color transformation process 910. The adaptive color transformation process 910 may produce transformed textures 915. The transformed textures 915 may include uv_mode and luminance-chrominance information for the 8 bpp textures 945.

The adaptive color transformation process 910 may determine the uv_mode for the 8×8 macro-block, according to the formulas as described with reference to the adaptive color transformation process 310 in FIG. 3. Because the adaptive color transformation process 910 may use the original RGB channels to determine the uv_mode, the 8 bpp textures 945 may first be decoded according to the decoding logic 700 to recover the original RGB channels. In an alternative implementation, the original RGB channels may be derived from the original textures 305.

Additionally, the RGB channels may be transformed to chrominance (UV) values according to the formulas described with reference to the adaptive color transformation process 310. As stated previously, the 4 bpp textures 250 may only include a sampling of chrominance values. As such, the chrominance values may only be determined for the texels represented by the Y-UV indices in the data structure 800.

FIG. 9B illustrates an example color index block 960, in accordance with implementations described herein. The index block 960 may be partitioned into four 2×2 blocks 965. As shown, each 2×2 block 965 may contain three Y indices and one Y-UV index. As such, the adaptive color transformation process 910 may only determine chrominance values for one texel in each 2×2 block 965. In one implementation, upon reconstruction, the chrominance values for the Y-UV-indexed texels may be shared with the Y-indexed texels in the same 2×2 block 965.

Referring back to FIG. 9A, the transformed textures 915 may be input to a local reduction process 920, which produces reduced textures 925 similar to the reduced textures 325 produced by the local reduction process 320 described with reference to FIG. 3. The local reduction process 920 may quantize the 16-bit floating point chrominance values to an 8-bit integer format with log encoding.

The local reduction process 920 may also determine the global luminance range (global luminance bound 830A and global luminance bound 830B) for the macro-block based on the global luminance bounds for each 4×4 block in the macro-block. Additionally, the local reduction process 920 may re-calculate the relative luminance values (base luminance value 840Y and base luminance value 850Y) for each 4×4 block based on the global luminance range for the macro-block.

The reduced textures 925 may be input to a joint channel compression process 930 and a point translation process 935, similar to the joint channel compression process 330 and point translation process 335, described with reference to FIG. 3. Because the chrominance values in the reduced textures 925 are only determined for 4 texels within each 4×4 block, the point translation process 935 may only be performed for 4 texels within each block.

In the 4 bpp compression, only 3 bits may be used for the table entry index. As such, only the first half of the modifier table 500 may be used in the point translation process 935.

The reduced textures may also be input to a luminance estimation process 940. The luminance estimation process 940 may determine the index values for the texels represented by Y indices. In one implementation, the Y indices may be interpolated between the base luminance value 840Y and the base luminance value 850Y for each 4×4 block.

In images with sharp edges, interpolating the Y indices may introduce visual artifacts that degrade the quality of the image. In such a case, texel prediction may be used to determine the Y-indexed texel values. The 2-bit Y index may indicate one of the four Y-UV-indexed texels used to determine the Y-indexed texel values.

Whether the Y indices indicate interpolation or texel prediction may be represented in a switch bit within the data structure 800. In one implementation, the switch bit may be represented implicitly by the arrangement of the base luminance value 840Y and base luminance value 850Y in the block 804-11.

The point translation process 940 may ensure an accuracy level in the vertical, horizontal, and diagonal directions (in the Y-UV-indexed texels) that accords with a representative luminance value for Y indexed texels. The luminance estimation process 940 may select interpolation or prediction based on the minimal square error for reconstruction.

Collectively, the joint channel compression process 930, the point translation process 935, and the luminance estimation process 940 may produce the 4 bpp textures 950.

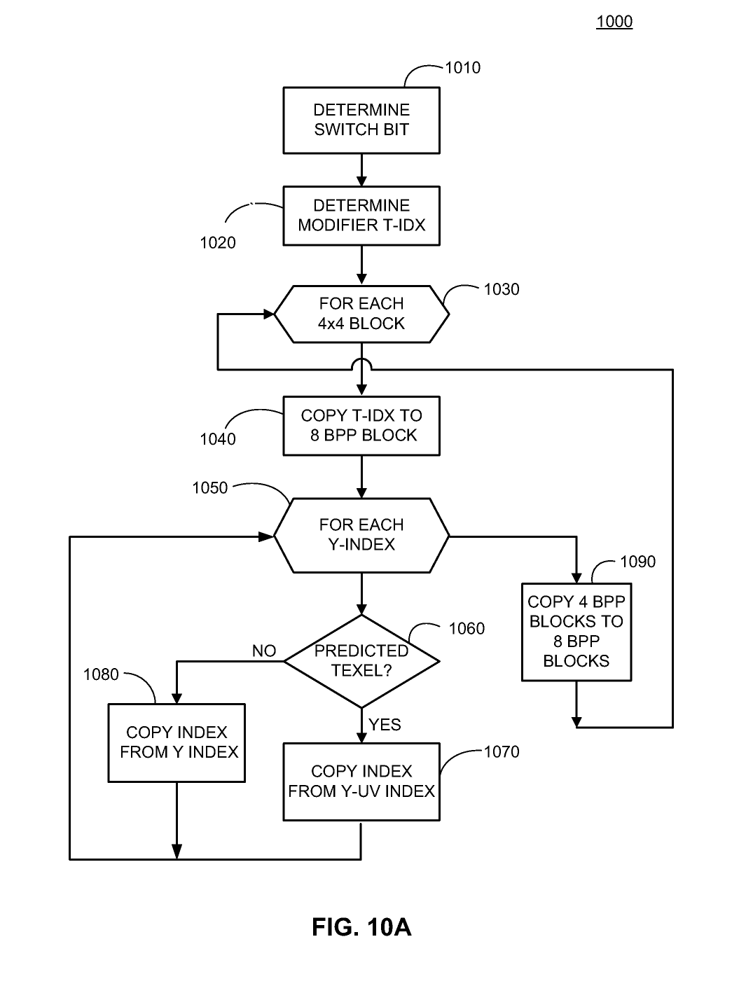

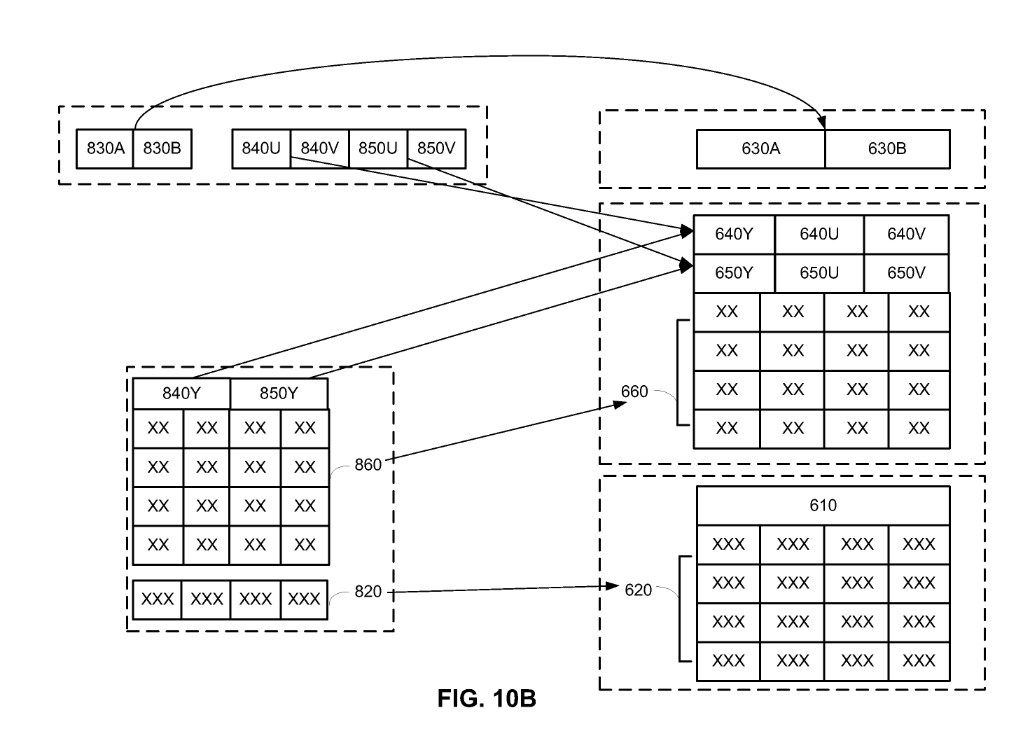

FIG. 10A illustrates a flow chart of a method 1000 for decoding 4 bpp textures 150 to 8 bpp textures 145. The method 1000 may convert 4 bpp textures 150 stored in the data structure 800 into 8 bpp textures 145 stored in the data structure 600. In one implementation, the method 1000 may be performed by the texel shader 160 for each macro-block in the 4 bpp textures 150. Once decoded, the RGB channels from the 8 bpp textures 145 may be recovered with the decoding logic 700.

At step 1010, the texel shader 160 may determine the switch bit for the Y index. The switch bit may indicate which method is used to indicate the luminance value of a Y-indexed texel: the interpolation or prediction method. The switch bit may be determined according to the description with reference to FIG. 8.

At step 1020, the texel shader 160 may determine the T_idx. The T_idx, along with the values in the modifier block 820 may identify the entry in the modifier table 500 used for point translated texels, i.e., Y-UV-indexed texels. The T_idx may be determined according to the description with reference to FIG. 8.

Steps 1030-1080 may be performed for each 4×4 block within the macro-block. At step 1040, the T_idx may be copied to the T_idx 610 in the data structure 600.

Steps 1050-1080 may be performed for each Y index in the index block 860.

At step 1060, if the switch bit indicates the texel represented by the Y index is a predicted texel, the method 1000 proceeds to step 1070. At step 1070, the index value of the Y-UV index indicated by the Y index value may be copied to the corresponding color index in the color indices 660 in the data structure 600.

If the switch bit indicates the texel represented by the Y index is not a predicted texel, the method 1000 proceeds to step 1080. At step 1080, the Y index value may be copied to the corresponding color index in the color indices 660 in the data structure 600.

After all the Y indices have been processed, at step 1090, the texel shader 160 may copy 4 bpp blocks from the 4 bpp textures 150 to their corresponding 8 bpp blocks in the 8 bpp textures 145.

FIG. 10B illustrates a block diagram indicating data copied from the 4 bpp textures 150 to the 8 bpp textures 145, in accordance with implementations described herein. As shown, the global luminance bound 830A and the global luminance bound 830B may be copied to the global luminance bound 630A and global luminance bound 630B, respectively.

The base chrominance values 840U and 840V, and base chrominance values 850U and 850V may be copied to the 640U, 640V, 650U, and 650V, respectively. The base luminance value 840Y and base luminance value 850Y may be copied to the 640Y and 650Y respectively.

As stated, the color indices 660 are copied from the Y-indexed texels before the block copy at step 1090. At step 1090, the Y-UV indices may be copied to their corresponding color indices 660.

The modifier block 820 may also be copied to the M_idx 620 values. As stated previously, the values in the modifier block 820 may represent the remaining Y-UV-indexed texels.

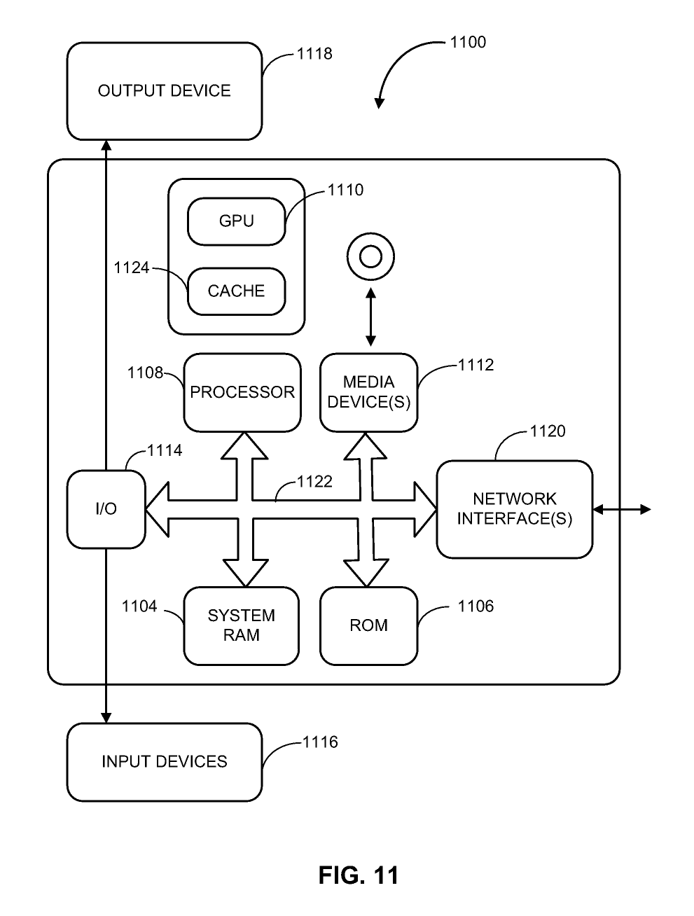

FIG. 11 illustrates a block diagram of a processing environment 1100 in accordance with implementations described herein. The coding and decoding methods described above can be applied to many different kinds of processing environments. The processing environment 1100 may include a personal computer (PC), game console, and the like.

The processing environment 1100 may include various volatile and non-volatile memory, such as a RAM 1104 and read-only memory (ROM) 1106, as well as one or more central processing units (CPUs) 1108. The processing environment 1100 may also include one or more GPUs 1110. The GPU 1110 may include a texture cache 1124. Image processing tasks can be shared between the CPU 1108 and GPU 1110. In the context of the present disclosure, any of the decoding functions of the system 100 described in FIG. 1 may be allocated in any manner between the CPU 1108 and the GPU 1110. Similarly, any of the coding functions of the method 200 described in FIG. 2 may be allocated in any manner between the CPU 1108 and the GPU 1110.

The processing environment 1100 may also include various media devices 1112, such as a hard disk module, an optical disk module, and the like. For instance, one or more of the media devices 1112 can store the original textures 205, the 8 bpp textures 245, the 4 bpp textures 250, and/or the storage format textures 270 on a disc.

The processing environment 1100 may also include an input/output module 1114 for receiving various inputs from the user (via input devices 1116), and for providing various outputs to the user (via output device 1118). The processing environment 1100 may also include one or more network interfaces 1120 for exchanging data with other devices via one or more communication conduits (e.g., networks). One or more communication buses 1122 may communicatively couple the above-described components together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for compressing textures, comprising:
transforming a first block of texels in a red-green-blue (RGB) space to a second block of texels in a luminance-chrominance space, the first block having red values, green values and blue values and the second block having luminance values and chrominance values, the chrominance values being based on a sum of the red values, a sum of the green values and a sum of the blue values;
sampling the chrominance values for a first subset of texels in the second block;
converting the luminance values and the sampled chrominance values to an 8-bit integer format;
modifying luminance values of the first subset to restore a local linearity property to the first subset; and
compressing the second block into a third block.

2. The method of claim 1, further comprising predicting luminance values of a second subset based on the luminance values of the first subset.

3. The method of claim 2, wherein the second subset is a remainder of texels in the second block beyond the first subset.

4. The method of claim 1 wherein the textures are LDR textures, and further comprising converting the first block of texels from a low dynamic range (LDR) format to a high dynamic range (HDR) format.

5. The method of claim 1, wherein the textures are high dynamic range textures.

6. The method of claim 1, wherein the first block is compressed at a compression ratio of 8 bits per pixel.

7. The method of claim 6, wherein the third block is compressed at a compression ratio of 4 bits per pixel.

8. The method of claim 1, wherein the third block is compressed at a compression ratio of 4 bits per pixel.

9. The method of claim 1, wherein the second block is compressed using a joint color-channel compression method.

10. The method of claim 9, wherein the joint color-channel compression method comprises a DirectX® texture-like linear fitting algorithm.

11. A computer-readable medium having stored thereon computer-executable instructions which, when executed by a computer, cause the computer to:
transform a first block of texels of a texture in a red-green-blue (RGB) space to a second block of texels in a luminance-chrominance space, the first block being compressed at 8 bits per pixel (bpp) and having red values, green values and blue values, and the second block having luminance values and chrominance values, the chrominance values being based on a sum of the red values, a sum of the green values and a sum of the blue values;
sample the chrominance values for a first subset of texels in the second block;
convert the luminance values and the sampled chrominance values to an 8-bit integer format;
modify luminance values of the first subset to restore a local linearity property to the first subset; and
compress the second block into a third block at a compression ratio of 4 bits per pixel.

12. The computer-readable medium of claim 11, further comprising computer-executable instructions which, when executed by a computer, cause the computer to:
predict luminance values of a second subset based on the luminance values of the first subset.

13. The computer-readable medium of claim 12, wherein the second subset is a remainder of texels in the second block beyond the first subset.

14. The computer-readable medium of claim 11 wherein the texture is an LDR textures, and further comprising computer-executable instructions which, when executed by a computer, cause the computer to:
convert the first block of texels from a low dynamic range (LDR) format to a high dynamic range (HDR) format.

15. The computer-readable medium of claim 11, wherein the texture is a high dynamic range textures.

16. The computer-readable medium of claim 11, wherein the second block is compressed using a joint color-channel compression method.

17. The computer-readable medium of claim 16, wherein the joint color-channel compression method comprises a DirectX® texture-like linear fitting algorithm.

18. A computer system, comprising:
a processor; and
a memory comprising program instructions executable by the processor to:
transform a first block of texels of a texture in a red-green-blue (RGB) space, to a second block of texels in a luminance-chrominance space, the first block being compressed at 8 bits per pixel (bpp) and having red values, green values and blue values, and the second block having luminance values and chrominance values, the chrominance values being based on a sum of the red values, a sum of the green values and a sum of the blue values;
sample the chrominance values for a first subset of texels in the second block;
convert the luminance values and the sampled chrominance values to an 8-bit integer format;
modify luminance values of the first subset to restore a local linearity property to the first subset;
compress the second block into a third block at a compression ratio of 4 bits per pixel; and
predict luminance values of a second subset based on the luminance values of the first subset.

19. The computer system of claim 18, wherein the memory further comprises program instructions, executable by the processor to convert the first block of texels from a low dynamic range (LDR) format to a high dynamic range (HDR) format.

20. The computer system of claim 18, wherein the second subset is a remainder of texels in the second block beyond the first subset.
